(19) United States
(12) Patent Application Publication
(10) Pub. No.: US 2025/0252343 A1
(43) Pub. Date: Aug. 7, 2025

(54) SYSTEM AND METHOD FOR A CONTEXT-BASED METHOD LABELING UNOBSERVED ENTITIES IN SEQUENTIAL DATA

(71) Applicant: Robert Bosch GmbH, Stuttgart (DE)

(72) Inventors: Ruwan Tharanga WICKRAMARACHCHIGE DON, Columbia, SC (US); Cory HENSON, Pittsburgh, PA (US)

(21) Appl. No.: 18/434,027

(22) Filed: Feb. 6, 2024

(51) Int. Cl. G06N 20/00; G06N 5/02

(52) U.S. Cl. CPC G06N 20/00; G06N 5/02

(57) ABSTRACT

A method includes receiving one or more datasets that includes one or more labels, identifying a first set of scenes associated with a first set of nodes and relations in a first sequence utilizing the datasets and labels to create a first window, identifying a second set of scenes associated with a second set of nodes and relations in a second sequence utilizing the e datasets and labels to create a second window, wherein the second window is in a future position compared to the first window, extracting a set of observed entities within the windows in response to inspecting the scenes across at the windows, determining the unobserved entities associated within a target scene utilizing at least the set of observed entities, wherein the target scene is sequentially between the first window and the second window, and augmenting the dataset.

### TECHNICAL FIELD

The present disclosure relates to machine learning networks, including those that utilizes sequential data to create scenes.

### BACKGROUND

Deep learning has shown much promise in solving challenging tasks with state-of-the-art performance in many real-world applications. A requirement that is common to deep learning algorithms is the availability of large training data. However, in many practical settings-especially in industrial applications-it is often difficult, impractical, or expensive to obtain large amounts of data with high-quality annotations. One popular way of addressing this challenge is through data augmentation. An assumption that is common to traditional data/label augmentation is that the label set for training data is accurate and complete. In many industrial applications, however, it should not be presumed that the labeling is complete. In other words, there may be entities (e.g., objects or events) in the training data that have gone unobserved and unlabeled.

### SUMMARY

A first embodiment discloses a method that includes receiving one or more datasets that includes one or more labels associated with objects within the dataset, identifying a first set of scenes associated with a first set of nodes and relations in a first sequence utilizing the one or more datasets and labels to create a first window, identifying a second set of scenes associated with a second set of nodes and relations in a second sequence utilizing the one or more datasets and labels to create a second window, wherein the second window is in a future position compared to the first window, extracting a set of observed entities within the first window and the second window in response to inspecting one or more scenes across at least the first window and second window, determining the one or more unobserved entities associated within a target scene utilizing at least the set of observed entities, wherein the target scene is sequentially between the first window and the second window, and augmenting the dataset with additional scene labels associated with the unobserved entities.

A second embodiment discloses a system that includes one or more sensors configured to retrieve image data, and a controller configured to receive one or more datasets including the image data, wherein the one or more datasets further includes one or more labels associated with objects within the dataset, identify a first set of scenes associated with a first set of nodes and relations in a first sequence utilizing the one or more datasets and labels to create a first window, identify a second set of scenes associated with a second set of nodes and relations in a second sequence utilizing the one or more datasets and labels to create a second window, wherein the second window is in a future position compared to the first window, extract a set of observed entities within the first window and the second window in response to inspecting one or more scenes across at least the first window and second window, determine the one or more unobserved entities associated within a target scene utilizing at least the set of observed entities, wherein the target scene is sequentially between the first window and the second window, and augment the dataset with additional scene labels associated with the unobserved entities.

A third embodiment discloses a computer-implemented method of labeling data for a machine learning (ML) models that includes receiving one or more images from one or more sensors, generating one or more datasets utilizing at least the one or more images and the machine learning model, receiving the one or more datasets that includes one or more labels associated with objects within the dataset, identifying a first set of scenes associated with a first set of nodes and relations in a first sequence utilizing the one or more datasets and labels to create a first window, identifying a second set of scenes associated with a second set of nodes and relations in a second sequence utilizing the one or more datasets and labels to create a second window, wherein the second window is in a future position compared to the first window, extracting a set of observed entities within the first window and the second window in response to inspecting one or more scenes across at least the first window and second window, determining the one or more unobserved entities associated within a target scene utilizing at least the set of observed entities, wherein the target scene is sequentially between the first window and the second window, and augmenting the dataset with additional scene labels associated with the unobserved entities.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3A illustrates an annotated scene and corresponding subgraphs in scene knowledge graph without applying an embodiment of the invention.

FIG. 3B illustrates an annotated scene and corresponding subgraphs in scene knowledge graph applying an embodiment of the invention.

FIG. 4A illustrates an embodiment of a representation of different elements of a sequential dataset of a scene in a knowledge graph.

FIG. 4B illustrates an embodiment of an overview of a scene windowing mechanism and unobserved entity inference according to one embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Sequential data is commonly found in industrial applications such as self-driving cars and smart manufacturing. Obtaining high quality, labeled sequence data for training machine learning models is an expensive and arduous task in such applications. Using prior knowledge for augmenting existing data/labels has been a recent focus within the machine learning community. In this disclosure, a system and method may utilize a specific type of label augmentation that enhances sequential data with additional labels for entities (e.g., objects and events) that have gone unobserved and, therefore, unlabeled in existing datasets. An embodiment of the invention may address this issue. The embodiment disclose may be a system and method in which sequential data is represented as a knowledge graph (KG) and analyzed to infer the unobserved entities (UEs). In one embodiment, the inference may leverage Piaget's theory of object continuity, a well-known theory in psychology, to determine if entities are present yet unobserved. Using autonomous driving as the application domain, the system may demonstrate the applicability of this method for augmenting driving scenes in two benchmark datasets—Pandaset and NuScenes—that include complex urban driving situations. In one example, the system and embodiment may be able to augment more than 12% and more than 38% of driving scenes with more than 8% and more than 18% additional labels for UEs in Pandaset and NuScenes, respectively. The system and method may allow for significant improvements in labeling entities that occur at the tail-end of the entity frequency distribution (e.g., entities that are rarely observed).

According to one embodiment, a system and method may include a specific-type of label augmentation of sequential data that may utilize Piaget's theory of object continuity in physical space. The disclosure below will included a detailed description and formalization of context-based method for labeling unobserved entities (“CLUE”) in sequential data. As well as a rule-based method for augmenting sequential data with additional entity labels. In one embodiment, the system may be implemented for context-based method (CLUE) with SPARQL queries executed against a scene knowledge graph.

Data and label augmentation may be a widely used technique in deep learning to address the issue of data scarcity and imbalance. It may improve the size of the training dataset by directly applying some transformation to the data to create new synthetic data. The transformations used in this regard can either be data modality-specific (e.g., image data, natural language processing or modality agnostic. Label augmentation may be another technique to address the data scarcity issue, where the labels of a small, curated dataset are used to annotate a large set of unlabeled data. Several semi-supervised learning approaches may be proposed for this task, such as pseudo-labeling and graph transduction that models data as a graph. While such methods are widely used for computer vision and NLP tasks, there has been information on data augmentations specific to time-series data. Such methods aim to exploit the intrinsic properties unique to time series, such as temporal dependency and the ability to transform the data into the frequency or time-frequency domains and apply the augmentations within the transformed domains. With respect to autonomous driving, several data augmentations have been proposed considering domain-specific problems. For example, object detection and annotation in degrading weather conditions remain a challenging and expensive task for state-of-the-art perception systems. The data augmentations have been proposed to improve the robustness for specific conditions such as rain, fog, and snow, considering the pixel-level scene data (for example, 2D images or 3D LIDAR point clouds). For example, some systems may utilize physics-based modeling and simulation to augment image data in KITTI (Karlsruhe Institute of Technology and Toyota Technological Institute) and Cityscapes datasets with rain and fog. Similarly, some systems may utilize a physics-based method for augmenting scenes with rain in LIDAR point clouds. Some systems and methods may utilize an approach for rendering snow and fog and reconstructing the existing scenes in AD datasets.

In one embodiment a scene may refer to a particular environment or context in which an algorithm is operating. A scene can encompass various elements, such as objects, people, backgrounds, lighting conditions, and other contextual factors associated with data. For instance, in computer vision, a scene might be a specific image or a frame from a video, and the goal could be to understand and interpret the content within that image or video frame. This may involve tasks like object detection, segmentation, and recognition. In natural language processing, a scene might refer to a specific context or situation described in a text. Understanding the scene can be crucial for tasks like sentiment analysis, information extraction, or question answering. In the context of autonomous vehicles, a scene may refer to the surroundings and elements present on the road, including other vehicles, pedestrians, road signs, and the overall environment. Scene understanding may allow for autonomous vehicles to make informed decisions about navigation and safety.

Despite sharing the common goal of augmenting existing datasets, it is important to note that proposed embodiment (i.e. CLUE) is significantly different from the previously mentioned methods. Irrespective of the underlying data modality or application domain, all of the previously mentioned data/label augmentations, at an abstract level, work on two basic assumptions: (1) the (small) annotated data set they start with is complete, and (2) the provided labels are accurate in describing the data. On the contrary, in CLUE, the system and method may assume the current labeling is accurate but potentially incomplete. In other words, the embodiment may assume there exists an additional set of labels for a given data point due to the fact that there may be objects and/or events that have gone unobserved. Thus, it is important to note that while previously mentioned methods expand the training dataset size, the proposed context-based method for labeling unobserved entities in sequential data (“CLUE”) aims to expand the number of labels per data point.

Continuity may refer to the understanding or assumption that entities continue to exist even when they are not directly sensed. For example, in a driving scene, a pedestrian continues to exist even when they are not observed. In this case, even if the pedestrian is no longer in direct view of the camera, they could be occluded by a large entity (e.g., a truck) or appear outside the camera's current field of view.

Sequential data can be represented in several ways. For example, in computer vision, a scene can be represented as a set of labeled bounding boxes drawn around 2D images or 3D point clouds. However, recent work, including some in data augmentation, has identified the limitations of this type of low-level representation as they are not expressive enough to capture the semantic and contextual information. The graph-based representation may be a possible alternative due to its rich and inherent ability to represent the relational knowledge. For example, in computer vision, scene graph generation may be aimed at representing the local context of the scene (e.g., the detected entities) as nodes in a graph, with direct edges representing the relationships between these entities. Next, in several industrial applications where sequential data is commonly found, there has been a recent interest in structuring domain semantics in ontologies and representing heterogeneous data in knowledge graphs. For example, several ontologies and knowledge graphs were introduced to represent manufacturing data in Industry 4.0 applications, and driving scenes in autonomous driving. In such an embodiment, KG-based representation of sequential data is adapted since it represents the context better than a dataset in its original form. Note that this may allow a system and method to perceive a scene as a volume of space and time.

To enable easy integration with existing applications, one embodiment may assume a KG representation of the sequence data. When implemented with a KG, the data augmentation provided by the embodiment may be akin to knowledge completion, as the newly derived entity labels may be encoded as triples and added to the KG. Unlike the traditional knowledge completion problem that completes missing nodes and relations of any kind, the embodiment disclosed may be able to complete a specific type of knowledge-such as, additional links connecting a scene to (unobserved) entity classes.

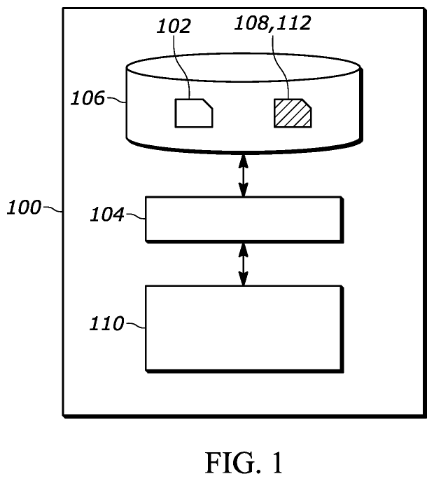

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

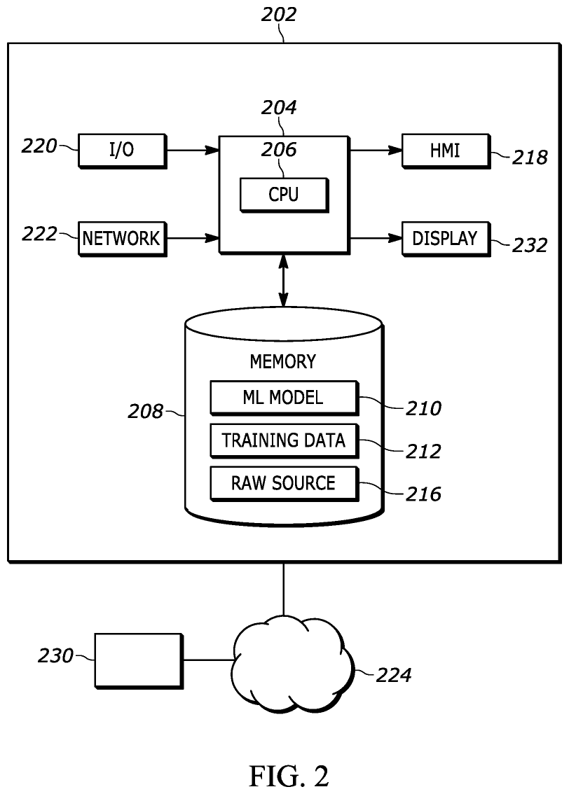

The structure of the system 100 is one example of a system that may be utilized to train the image-to-image machine-learning model and the mixer machine-learning model described herein. Additional structure for operating and training the machine-learning models is shown in FIG. 2.

FIG. 2 depicts a system 200 to implement the machine-learning models described herein, for example the image-to-image machine-learning model, the mixer machine-learning model, and the pre-trained reference model described herein. The system 200 can be implemented to perform image quantization processes described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

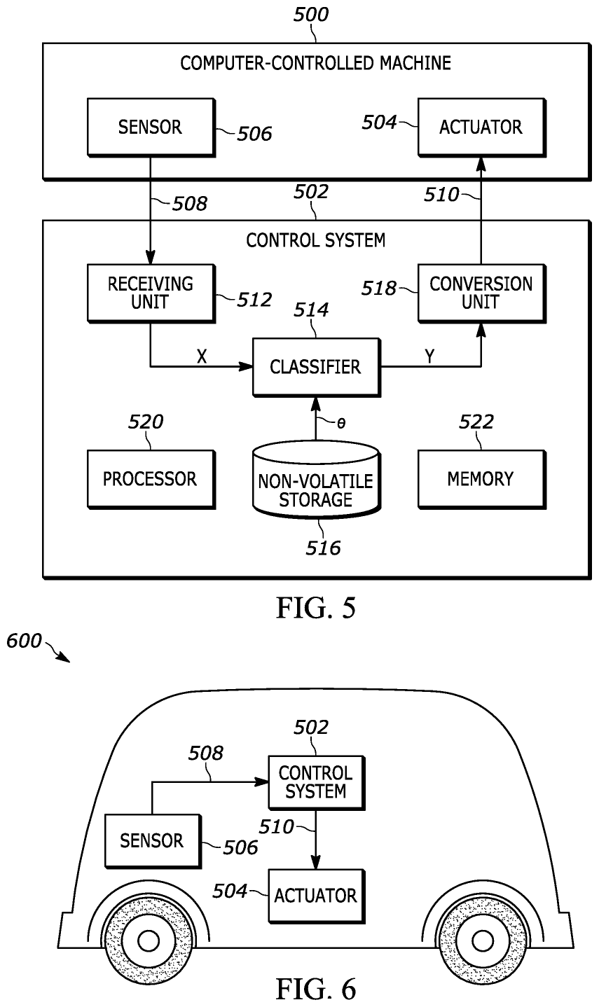

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the image-to-image machine-learning model, the mixer machine-learning model, and the pre-trained reference model described herein.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithms (e.g., image-to-image machine learning model, mixer machine-learning model, and pre-trained reference model) described herein, the output can be a quantized version of the input image.

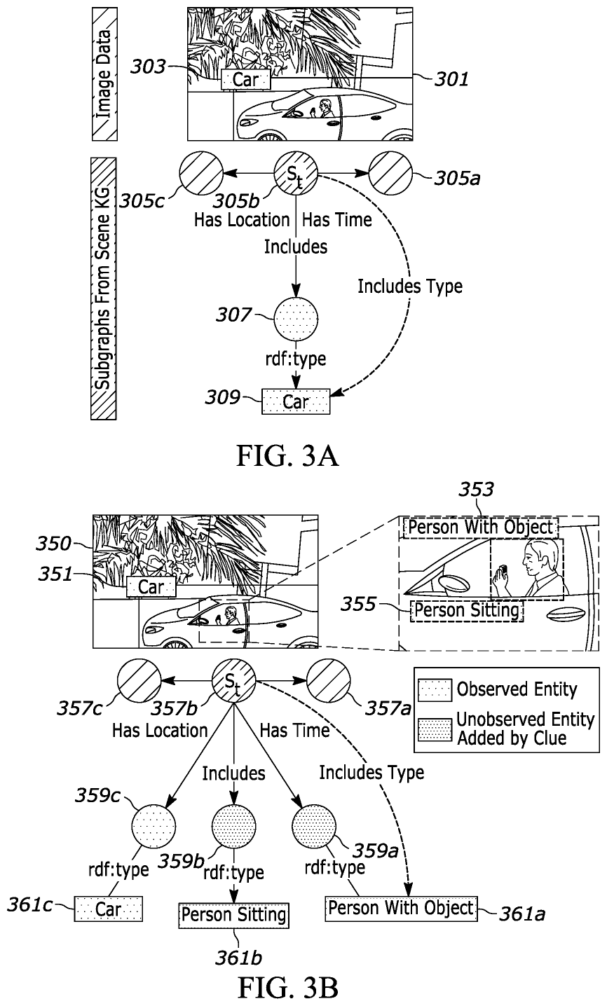

FIG. 3A illustrates an example of an annotated scene utilizing a large-scale dataset. For example, in one embodiment Pandaset may be utilized, which is a large-scale data set for autonomous driving research and development. It may facilitate the training and evaluation of computer vision algorithms for tasks such as object detection, segmentation, and tracking in the context of self-driving cars. As such, the embodiment may show an annotated scene from Pandaset and its corresponding subgraph in scene knowledge graph. The image data 301 may include a car in an environment that includes a label 303 for the “car.” Thus, the image data 301 may show an image that identifies an object, such as a car. However, any image data may be utilized and any object or entity may be shown. The image data may also include sound, vision image data (e.g. LiDar, Radar, etc.). The subgraphs from the scene knowledge graph may be shown as well. The knowledge graph may identify scenes 305a, 305b 305c in various types. The model may identify an entity 307 as related to the scene and tie the scene to including a label associated with the scene 305b. The knowledge graph may model the KG label subgraph 309 to the scene.

FIG. 3B illustrates the same scene as that of FIG. 3A, however, utilizing additional entity labels augmented by an embodiment of the invention and how its subgraph is completed with this new knowledge about unobserved entities. According to one embodiment, the image data 350 may include a label of a car 351. As opposed to the embodiment shown in FIG. 3A, the image data may include additional labels for the unobserved entities. For example, while the car was originally identified, now the system may include a first label 353 of an unobserved entity and a second label 355 of an unobserved entity. For example, the first label 353 may indicate a “person with object” and the second label 355 may indicate “person sitting.” Thus, the unobserved entities may be added to the dataset for additional observations or image recognition. The updated knowledge graph may identify scenes 357b or various nodes 357a, 357c. For example, a node 357c in the knowledge graph may represent the location of scene 357b. In another example, another node 357a may indicate a timing as related to the scene 357b. The knowledge graph may generate various nodes to tie to relationships to create various labels. For example, the various entity nodes (e.g. subgraphs) 359a, 359b, 359c may be tied to the scene, as well as the label subgraphs 361a, 361b, 361c. The entity subgraph 359a may be tied to the label subgraph 361a to indicate “person with object”. The model may identify an entity subgraphs 359a, 359b, 359c as related to the scene and tie the scene to including a label subgraph subgraphs 361a, 361b, 361c associated with the scene 305b.

In one embodiment, the system and method may be applied to autonomous driving (“AD”) as the application domain to demonstrate entity label augmentation with CLUE or any other embodiment of the invention. Autonomous driving may be beneficial because several high-quality, annotated and open sequential datasets are available, and recent work has introduced several KGs generated from such data. Furthermore, AD has the inherent problem of entities going unobserved and unlabeled within driving scenes due to several perception failures, such as occlusion, sensor failures, objects appearing outside the field of view, etc. Due to this reason, the set of labels provided for a driving scene may be incomplete.

In CLUE or any other embodiment of the invention, entity label augmentation is may be accomplished through analysis of the context of a scene. The system and method may be leveraging Piaget's theory of object continuity (or continuity assumption) within this context. In this case, the context is defined as the sequence of scenes surrounding the target scene. Continuity may refer to the understanding, or assumption, that entities continue to exist even when they are not directly observed. For example, in a driving scene, a pedestrian continues to exist even when they are no longer in direct view of the camera. In this case, the pedestrian could be occluded from view by standing behind another large entity (e.g., a truck) or simply outside the camera's current field of view.

The situation in which an entity is present in a target scene but not observed can be inferred through analysis of its context, e.g., the sequence of scenes surrounding the target scene, including prior and/or subsequent scenes. Note that the concept of scene here refers to the spatial-temporal region surrounding the ego-vehicle. The use of this technique to detect and label previously unobserved entities provides several benefits. First, the ability to label additional entities in a scene may be used to validate the performance of existing labeling methods (e.g., for computer vision). Second, it allows for the creation of ground-truth/gold labels data to be used by prediction approaches that are either vision-based or non-visual/semantic in nature, such as link prediction (Knowledge-based Entity Prediction (KEP)) and node classification).

In one example, if a system and method may consider a sequential dataset D: {(f₁, y₁), (f₂, y₂), . . . , (fₙ, yₙ)} where y₁={l₁, l₂, . . . , lₖ is the set of labels provided for data point fᵢ, and {f₁, . . . , fₙ} in D are ordered by time. Given D, our problem is to find \hat{D}←φ(D) where φ is the entity label augmentation/inference model. The resultant dataset with label augmentations is \hat{D}={(f₁, γ₁), (f₂, \hat{γ}₂), . . . , (fₙ, \hat{γ}ₙ)} where ŷᵢ={l₁, l₂, . . . lₖ, lₖ₊₁, . . . , lₘ} such that |\hat{γ}ᵢ|>|yᵢ|. Hence, the additional set of labels fᵢ is augmented with is {lₖ₊₁, . . . , lₘ}.

Such a problem statement may allow the system and method to examine any sequential dataset that naturally fits the multi-label classification problem setting. To make it easily adaptable to existing applications, the system may consider the KG representation of sequential data (D) and devise our solution accordingly. The system and method may focus on adding new labels for unobserved entities. In one embodiment, this would be reflected on \hat{D} as an increase in the number of labels per data point while not affecting the size of the dataset (i.e., |D|=|\hat{D}|). This type of label augmentation, when implemented with a KG, is akin to knowledge completion. Unlike the past systems with knowledge completion problem, however, the current problem setting is expected to complete a specific type of knowledge—e.g., additional links connecting a scene to (unobserved) entity classes.

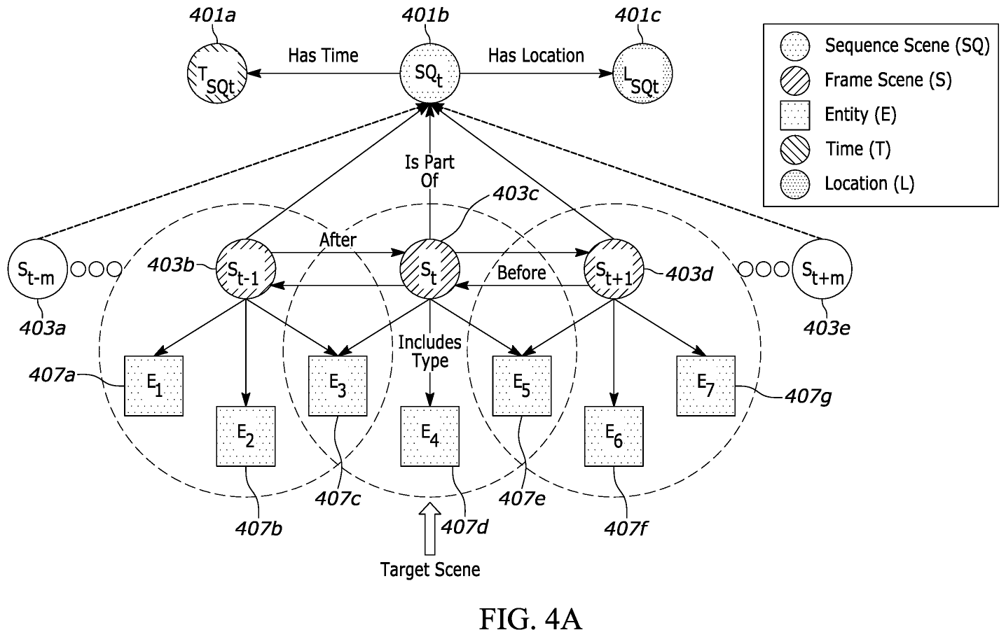

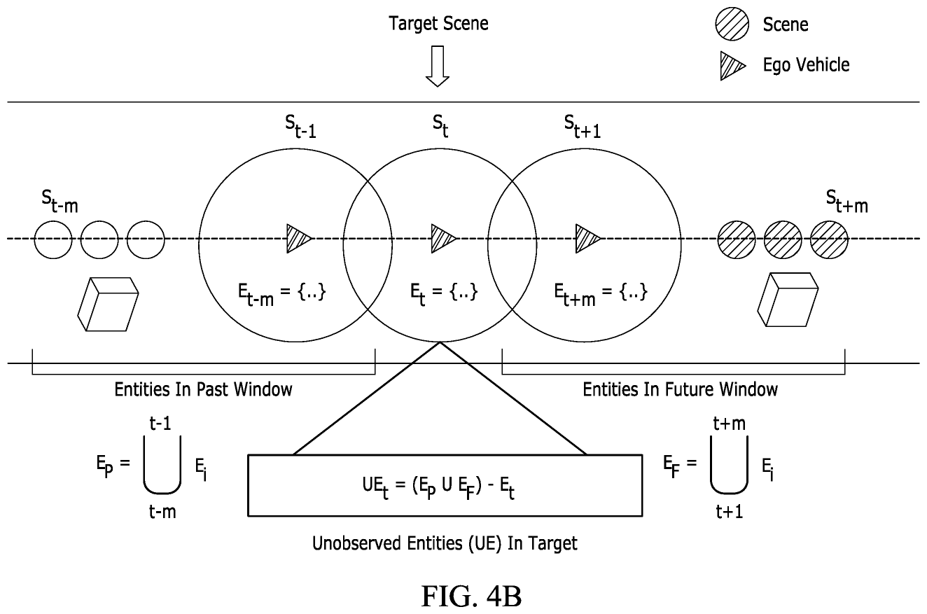

FIG. 4A illustrates an embodiment of a representation of different elements of a sequential dataset of a scene in a knowledge graph. One or more sequence scenes 401b (with a corresponding time 401a and location 401c) may be generated utilizing the image data form a dataset. The sequence scenes may include sequential data. In one embodiment to have a richer representation of sequential data, the embodiment may utilize scene ontology and knowledge graph. A scene knowledge graph is a knowledge graph (KG) that may be conformant to the scene ontology. One of the central concepts of the scene ontology is a scene, which may represent a volume of space-time. There may be two types of scenes: (1) FrameScene 403a, 403b 403c, 403d, 403e representing a specific point in time, and (2) SequenceScene 401a, 401b, 401c representing a duration of time)). A FrameScene 403a, 403b 403c, 403d, 403e may be part of a SequenceScene 401b and a SequenceScene 403a, 403b 403c, 403d, 403e is comprised of several FrameScenes 403a, 403b 403c, 403d, 403e. Within a sequence, FrameScenes are linked together with before and after relations. A FrameScene 403a, 403b 403c, 403d, 403e may include an Entity 407a. 407b, 407c, 407d, 407e, 407f, 407g (e.g., an object or event). For example, frame scene 403b may include entities 407a, 407b, 407c. This is represented as a link between a FrameScene and an entity class (denoted simply as Entity) through an “IncludesType” relation. When representing sequential data using Scene KG, each data point may be instantiated as a FrameScene, and each label can be considered as an Entity. In addition to maintaining temporal order between data points, the Scene KG may allow us to define additional semantic relations that exist in the data. For example, in visual processing datasets, each sampled and labeled frame of a video can be represented as a FrameScene while the video itself may be represented as a SequenceScene. Thus, the representation of different elements of a sequential dataset in Scene KG is shown in FIG. 4A. Primarily, the dataset can be structured into a collection of two types of scenes (e.g., SequenceScene and FrameScene) along with other attributes such as location, time and semantic relationships among nodes.

Table 1 shows the primary relations in Scene Ontology.

TABLE L
A subset of relations in the Scene
Ontology (prefix: scn) used by CLUE

| Relation | Subject | Object |
|---|---|---|
| after | FrameScene | FrameScene |
| before | FrameScene | FrameScene |
| includesType | FrameScene | Entity |
| isPartOf | FrameScene | SequenceScene |

FIG. 4B illustrates an embodiment of an overview of a scene windowing mechanism and unobserved entity inference according to one embodiment. In one embodiment, the system and method may label unobserved entities with the CLUE method. The CLUE method for labeling unobserved entities may utilize the premise of the continuity assumption. More specifically, it may detects and label entities that are observed in the context of the target scene, but are not observed in the target scene itself. This method is implemented in two primary steps: (1) employing a scene windowing mechanism for defining the target scene context, (2) inferring the presence of unobserved entities in the target scene. Next, the system and method may formalize each of these steps.

A scene windowing mechanism may be used to define and analyze the context (e.g., surrounding scenes) of a target scene. As shown in FIG. 4B, this can be configured to inspect k scenes (size of the window) across multiple positions—the window of future scenes, the window of past scenes or windows of both past+future scenes). Considering a dataset represented as a Scene KG, the system may formalize the unobserved entity (UE) labeling.

In one embodiment, G:N×R×N be the scene knowledge graph where N is the set of nodes and R is the set of relations. Considering different types of nodes in N, let S={s₁, s₂, . . . , sᵢ, . . . , sₙ}⊆N be the set of scenes, and E={e₁, e₂, . . . , eⱼ, . . . eₘ}⊆N be the set of entity classes.

For a scene sᵢ and entity eⱼ, the system can define the includesType relation as:

$$includesType ⊆ \{ {s}_{i} \vert {s}_{i} ∈ S \} \times E \qquad ( 1 )$$

$$Such that ( {s}_{i} , {e}_{j} ) ∈ includesType whenever {e}_{j} ∈ E$$

For a scene sᵢ, the system can define the set of included entities E(sᵢ) as:

$$E ( {s}_{i} ) = \{ {e}_{j} \vert ( {s}_{i} , {e}_{j} ) ∈ includesType \} \qquad ( 2 )$$

The system may let,

$$S = {s}_{0} {s}_{1} … {s}_{n} \qquad ( 3 )$$

be a sequence (ordered by time) of scenes. Considering this sequence, the system and method will define the window of future scenes and the window of past scenes with respect to a particular target scene (sₜ) as follows:

The system and method may consider a window of future scenes. Let sₜ be a scene in S, designated as the target scene, with t∈{0, . . . , n}. Then for st the future window of length l≥0 is represented by Fₛ(sₜ, l) and is a sequence sᵢ₁sᵢ₂ . . . sᵢₗ such that for any m∈{0, 1, . . . , l−1} will have:

$${i}_{l - m} = t + l - m \qquad ( 4 )$$

And l is such that t+l≤n.

The system and method may consider a window of past scenes. Let st be a scene in S, designated as the target scene, with t∈{0, . . . , n}. Then for sₜ the past window of length l≥0 the past window of length Pₛ(sₜ, l) and is a sequence sᵢ₁sᵢ₂ . . . sᵢₗ such that for any m∈{0, 1, . . . , l−1}
the embodiment may have:

$${i}_{l - m} = t - l + m \qquad ( 5 )$$

And l is such that t−l≥0.

The system and method may include inferring unobserved entities. The next step is to infer the set of entities that are not observed in the target scene, but are observed within the target scene context, which is represented by the specified window. The UE inference is performed by first extracting a set of observed entities within the window specified (Eq. 6) and then analyzing it to determine the unobserved entities for the target scene (Eq. 7).

Set of observed entities (OEs) within a window E(W): Now, considering Eq. (2) & (3) above, the entities within a window sequence S=W can be obtained by:

$$E ( W ) = {⋃}_{i}^{n} E ( {s}_{i} ) \qquad ( 6 )$$

Set of unobserved entities (Uₜ) within a target scene (sₜ): Considering (2) and (6), the set of unobserved entities within a target scene sₜ can be obtained by:

$${U}_{t} = E ( {W}_{t} ) - E ( {s}_{t} ) \qquad ( 7 )$$

such that the window for target scene sₜ is Wₜ∈{Pₛ(·), Fₛ(·), Pₛ(·)∪Fₛ(·)}

Once the unobserved entities inference step is complete, the dataset may be augmented with additional scene labels for this set of unobserved entities. Thus, the data set may include expanded object/entity recognition that was not available in the dataset prior.

An algorithm for the CLUE method may be utilized in one embodiment. The algorithm shown below (e.g., Algorithm 1) may illustrate an example of pseudocode of the CLUE method for generating labels for unobserved entities Uₜ for a given target scene index sₜ, considering the future window position. First, the set of observations/labels for sₜ is obtained in line 1. Then, the context of sₜ—represented by the window of future scenes (Fₛ)—is defined in line 4. Lines 6-15 show the process of navigating across each scene within the window of future scenes to obtain the set of unique entities observed (i.e., E(W) in Eq. 6). Note that, during this process, the position an entity is observed within the Fₛ is maintained (i.e., how many scenes away an entity is observed from the target). In line 16, the set of unobserved entities Uₜ of sₜ is obtained. As the last step, the position information saved earlier is used to quantify the confidence of including an unobserved entity in the target. Equation 8 can be a simple example of the function φ to compute a confidence score. It obtains the reciprocal of the minimum offset/closest scene index an entity is observed within the window.

$${C}_{j} = Φ ( {U}_{tmp} \vert {e}_{i} \vert ) = max ( {c}_{1} , … , {c}_{j} , … , {c}_{n} \vert {c}_{j} = \frac{1}{j + 1} ∈ {U}_{tmp} \vert {e}_{i} \vert ) \qquad ( Equation 8 )$$

Algorithm 1: CLUE method for obtaining UE's for window position “Future”

Input: Original dataset: D, target index: sₜ, window size: wₗ, window position: Wₚ
Output: Unobserved entities of sₜ and their confidence values: Uₜ, Cₜ

| 1 | eₛ_{ₜ}← E(sₜ) | | | |
|---|---|---|---|---|
| 2 | if wₚ == ‘Future’ then | | | |
| 3 | | Ew ← {φ} ; // Define an empty data structure to hold E(W) as KEY-VALUE | | |
| | | pairs | | |
| 4 | | Fₛ ← D[start = sₜ + 1 : end = sₜ + wₗ] ; // Define the context of sₜ | | |
| 5 | | i ← 0 | | |
| | | // Iterate over all scenes in the Fₛ (i.e., context of sₜ) | | |
| 6 | | foreach sᵢ ∈ Fₛ do | | |
| | | | // Iterate over all observed/labeled entities of sₜ | |
| 7 | | foreach eⱼ ∈ E(sᵢ) do | | |
| 8 | | | if eⱼ ∉ KEYS (Ew ) then | |
| | | | | // Remember how far away the eⱼ is observed from sₜ |
| 9 | | | | Ew [eⱼ] ← [i] |
| 10 | | | else | |
| | | | | // In cases where eⱼ is observed more than once in Fₛ |
| 11 | | | | APPEND (Ew [eⱼ], i) |

| | |
|---|---|
| 12 | end |

| | |
|---|---|
| 13 | end |
| 14 | i ← i + 1 |

| | |
|---|---|
| 15 | end |
| | // Obtain the UE's along with the distance (i.e., how many scenes |
| | away they were observed) |
| 16 | Uₜ = {KEYS (Ew ) - eₛₜ} |
| 17 | Uₜₘₚ(e, d) ← {e : Ew [e] ∀ e ∈ Uₜ} |
| 18 | Cₜ ← ΦUₜₘₚ) // Compute confidence scores using Φ(.) |
| 19 | return {Uₜ, Cₜ} |

| | |
|---|---|
| 20 | end |

The primary steps of CLUE can be implemented into any time of query database, such as a SPARQL query or a similar query. The goal of the query is to derive unobserved entities within a target scene. This is accomplished by selecting all entities in the scene knowledge graph that are included in the past or future window (e.g. context) but not included in the target scene. In one embodiment, a query can be composed into four components: (1) define the target scene (line 3 below), (2) aggregate entities in the past window (lines 4-7 below), (3) aggregate entities in the future window (lines 8-11 below), and (4) filter all entities included in the target scene from the aggregated set (line 12 below). In the example provided, entities are aggregated within a past and future window of size 2 (e.g. the two scenes directly prior to and subsequent to the target scene).

SPARQL Implementation

| | |
|---|---|
| 1 | SELECT DISTINCT ?entity |
| 2 | WHERE { |
| 3 | BIND (:<TARGET_ID> AS ?target) |
| 4 | { ?target scn:before ?past . |
| 5 | ?past scn:includesType ?entity } |
| 6 | UNION { ?target scn:before/scn:before ?past . |
| 7 | ?past scn:includesType ?entity } |
| 8 | UNION { ?target scn:after ?future . |
| 9 | ?future scn:includesType ?entity } |
| 10 | UNION { ?target scn:after/scn:after ?future . |
| 11 | ?future scn:includesType ?entity } |
| 12 | MINUS { ?target scn:includesType ?entity } |
| } | |

For example, the system and method may be utilized to define the target scene. To define the target scene, the system may bind the URI of the target scene to a variable (?target). BIND (:<TARGET_ID>AS ?target).

As related to the second part of the query, the system and method may aggregate entities in the past window. To aggregate entities in the past window, for each scene in the past window create a UNION clause with a variable representing the past scene (?past) and a variable representing the entities (?entity) included in the past scene. To streamline the query, the property path4 syntax may be used to link the target scene to the past scene through the scn:before relation. {?target scn:before ?past·?past scn:includesType ?entity} UNION {?target scn:before/scn:before ?past·?past scn:includesType ?entity}

As related to the third part of the query, the system and method may aggregate entities in the future window. Aggregating entities in the future window may be similar to aggregating entities in the past window. One of the differences is that the scn:after relation is used to link subsequent scenes in the sequence. {?target son:after ?future·?future scn:includesType ?entity} UNION {?target scn:after/scn:after ?future·?future scn:includesType ?entity}

As related to the fourth component of the query, the system and method may filter entities in the target scene. To find entities in the past or future window, but not in the target scene, simply append a MINUS clause to remove entities from the aggregated set that are also included in the target scene. MINUS {?target sen:includesType ?entity} The CLUE query described above is able to derive the unobserved entities associated with a target scene. For knowledge completion purposes, the system and method may want to update the scene knowledge graph with these unobserved entities. To accomplish this, simply replace the SELECT clause of the SPARQL query with an INSERT clause. INSERT {?target scn:includesType ?entity}

The machine-learning models described herein can be used in many different applications. Additional applications are shown in FIGS. 6-11. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

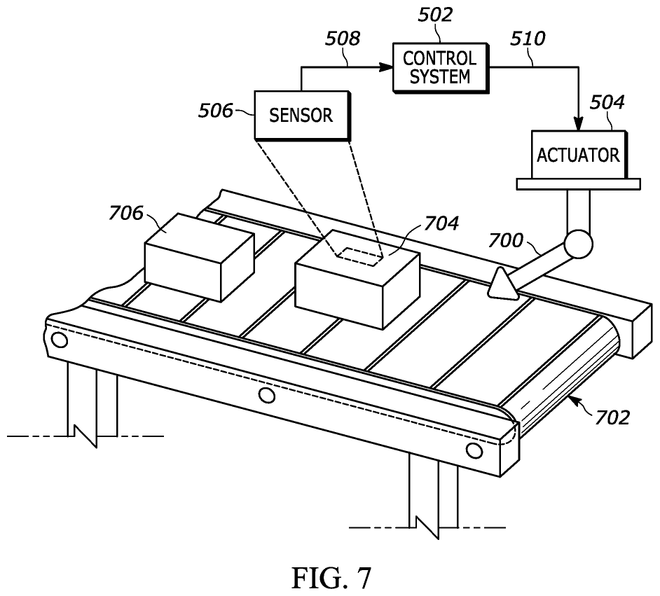

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

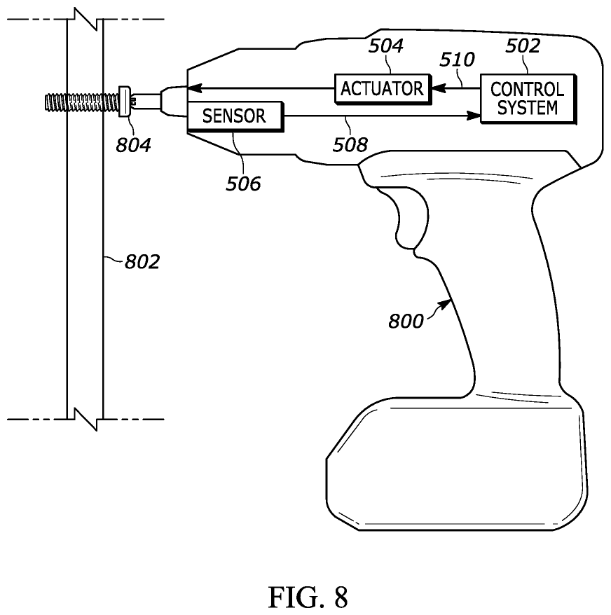

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

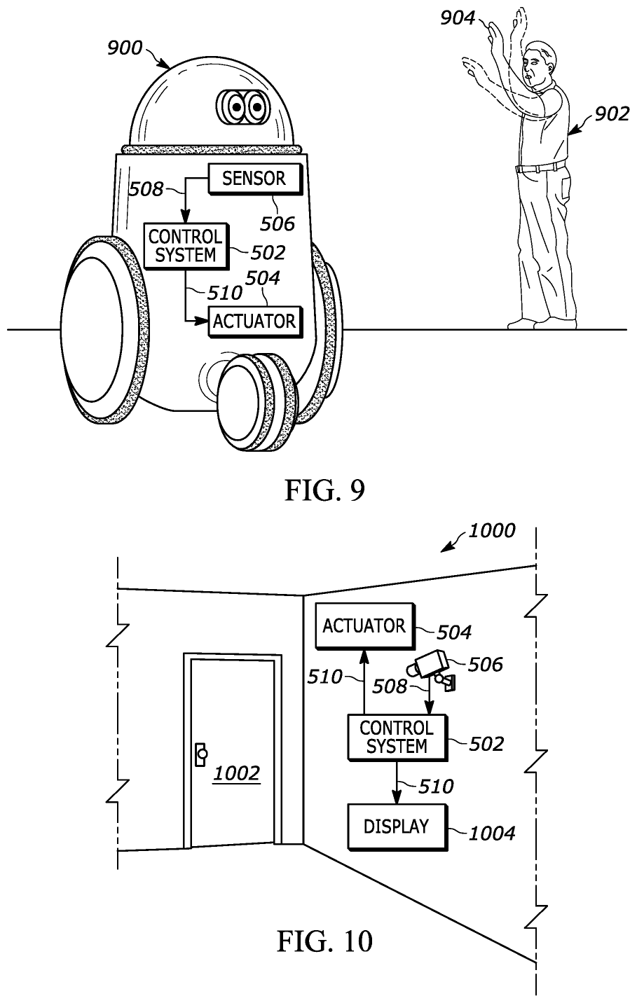

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face. In one embodiment, CLUE may be utilized to detect a person in a specific object of the monitoring system.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

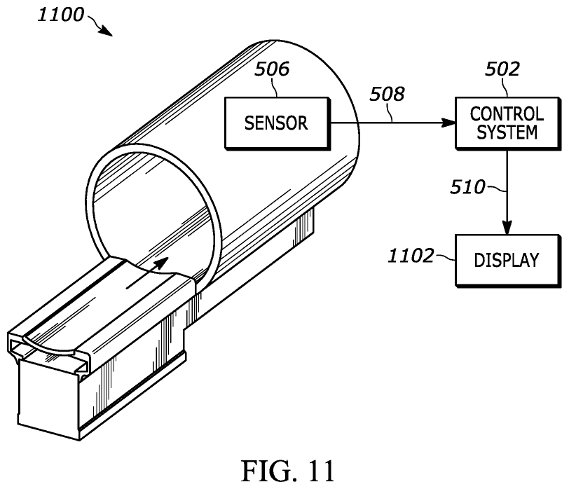

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of labeling data for machine learning (ML) models, the method comprising:
receiving one or more datasets that includes one or more labels associated with objects within the dataset;
identifying a first set of scenes associated with a first set of nodes and relations in a first sequence utilizing the one or more datasets and labels to create a first window;
identifying a second set of scenes associated with a second set of nodes and relations in a second sequence utilizing the one or more datasets and labels to create a second window, wherein the second window is in a future position compared to the first window;
extracting a set of observed entities within the first window and the second window in response to inspecting one or more scenes across at least the first window and second window;
determining the one or more unobserved entities associated within a target scene utilizing at least the set of observed entities, wherein the target scene is sequentially between the first window and the second window; and
augmenting the dataset with additional scene labels associated with the unobserved entities.

2. The method of claim 1, determining the one or more unobserved entities includes determining a confidence score associated with the one or more unobserved entities and exceeding a threshold associated with the confidence score.

3. The method of claim 1, wherein the multiple positions includes one or more window of future scenes or one or more windows of past scenes.

4. The method of claim 1, wherein the multiple positions includes one or more window of future scenes and one or more windows of past scenes.

5. The method of claim 1, wherein the dataset includes time-series data.

6. The method of claim 1, wherein the unobserved entities includes two or more objects associated with the one or more labels.

7. The method of claim 1, wherein the dataset is associated with autonomous driving, natural language processing, or audio information.

8. The method of claim 1, wherein extracting the set of observed entities includes removing duplicates associated with a class of objects.

9. A system, comprising:
one or more sensors configured to retrieve image data; and
a controller configured to:
receive one or more datasets including the image data, wherein the one or more datasets further includes one or more labels associated with objects within the dataset;
identify a first set of scenes associated with a first set of nodes and relations in a first sequence utilizing the one or more datasets and labels to create a first window;
identify a second set of scenes associated with a second set of nodes and relations in a second sequence utilizing the one or more datasets and labels to create a second window, wherein the second window is in a future position compared to the first window;
extract a set of observed entities within the first window and the second window in response to inspecting one or more scenes across at least the first window and second window;
determine the one or more unobserved entities associated within a target scene utilizing at least the set of observed entities, wherein the target scene is sequentially between the first window and the second window; and
augment the dataset with additional scene labels associated with the unobserved entities.

10. The system of claim 9, the controller is further configured to determine a confidence score associated with the one or more unobserved entities and exceeding a threshold associated with the confidence score.

11. The system of claim 9, wherein the controller is further configured to generate a knowledge graph utilizing at least the dataset.

12. The system of claim 9, wherein the multiple positions includes one or more window of future scenes and one or more windows of past scenes.

13. The system of claim 9, wherein the dataset is PandaSet.

14. The system of claim 9, wherein the unobserved entities includes two or more objects associated with the one or more labels.

15. The system of claim 9, wherein the dataset is associated with an industrial application.

16. The system of claim 9, wherein the controller is further configured to remove duplicate entities associated with a class of objects.

17. A computer-implemented method of labeling data for a machine learning (ML) models, the method comprising:
receiving one or more images from one or more sensors;
generating one or more datasets utilizing at least the one or more images and the machine learning model;
receiving the one or more datasets that includes one or more labels associated with objects within the dataset;
identifying a first set of scenes associated with a first set of nodes and relations in a first sequence utilizing the one or more datasets and labels to create a first window;
identifying a second set of scenes associated with a second set of nodes and relations in a second sequence utilizing the one or more datasets and labels to create a second window, wherein the second window is in a future position compared to the first window;
extracting a set of observed entities within the first window and the second window in response to inspecting one or more scenes across at least the first window and second window;
determining the one or more unobserved entities associated within a target scene utilizing at least the set of observed entities, wherein the target scene is sequentially between the first window and the second window; and
augmenting the dataset with additional scene labels associated with the unobserved entities.

18. The computer-implemented method of claim 17, wherein the method includes creating a knowledge graph utilizing at least the first set of scenes, the first set of nodes and relations in the first sequence, and the one or more labels.

19. The computer-implemented method of claim 17, wherein the method includes creating a knowledge graph utilizing at least the first set of scenes, the first set of nodes and relations in the first sequence, the one or more labels, and the additional scene labels.

20. The computer-implemented method of claim 17, wherein the knowledge graph includes a link between an entity graph and label graph.
